(19) United States
(12) Patent Application Publication
(10) Pub. No.: US 2025/0007357 A1
(43) Pub. Date: Jan. 2, 2025

(54) MOTOR

(71) Applicant: NIDEC CORPORATION, Kyoto (JP)

(72) Inventors: Xiuquan DONG, Dalian (CN); Liu LING, Dalian (CN); Baojun LUAN, Dalian (CN); Hao WU, Dalian (CN); Changxu LI, Dalian (CN)

(21) Appl. No.: 18/754,617

(22) Filed: Jun. 26, 2024

(30) Foreign Application Priority Data
Jun. 30, 2023 (CN) 202310799055.2

(51) Int. Cl. H02K 11/00; H02K 1/12; H02K 5/04

(52) U.S. Cl. CPC H02K 11/0094; H02K 1/12; H02K 5/04

(57) ABSTRACT

A motor includes a casing including an opening portion on one axial side of an outer circumferential wall extending circumferentially around a central axis, and a bottom on the other axial side of the outer circumferential wall, and a molded stator assembly including a stator, a busbar assembly, and a molded resin. The busbar assembly includes a metal busbar and is supported on the stator. The molded resin covering the busbar assembly axially is located on one axial side of the stator and includes protrusions protruding towards the axial side, on a section perpendicular to the axial direction. The projection of the busbar and the projection of the protrusion overlap at least partially. The molded resin is filled between the busbar and the protrusion. Therefore, the strength of the protrusions is increased, which facilitates assembling the molded stator assembly.

### CROSS-REFERENCE TO RELATED APPLICATIONS

The present application claims priority under 35 U.S.C. § 119 to Chinese Patent Application No. 202310799055.2, filed on Jun. 30, 2023, the entire contents of which are hereby incorporated herein by reference.

### 1. FIELD OF THE INVENTION

The present application relates to the electromechanical field, in particular to motors.

### 2. BACKGROUND

During an assembly process of a motor, it is usually necessary to assemble a molded stator iron core and a casing. The existing general method is to allow a tool to abut against a molded resin surface, such that the stator iron core is pressed into the casing from an opening side of the casing.

It should be noted that the above introduction to the technical background is only for the convenience of a clear and complete description of the technical solutions of the present application, and for the convenience of understanding by those skilled in the art. It cannot be considered that the above technical solutions are known to those skilled in the art just because these solutions are described in the background section of the present application.

### SUMMARY

The inventors of the present application have discovered that in the process of assembling the motor through the above method, a molded resin surface will be cracked due to insufficient strength of resin, when an assembling tool abuts against the molded resin surface and applies a pressure.

According to an example embodiment of the present application, a motor includes a stator assembly which is molded. The stator assembly includes a stator, a busbar assembly, and a molded resin. The busbar assembly is supported on the stator, and the molded resin covers the busbar assembly in an axial direction. The busbar assembly includes a metal busbar. The molded resin is located on one axial side of the stator and includes protrusions that protrude toward axial side. In a cross section perpendicular to the axial direction, a projection of the busbar at least partially overlaps with a projection of the protrusion. The molded resin is filled between the busbar and the protrusion.

In at least one example embodiment, the busbar includes claw portions that clamp a coil lead wire of the stator, and, in a cross section perpendicular to the axial direction, the projection of the protrusion at least partially overlaps with a projection of the claw portion.

In at least one example embodiment, the claw portion extends into the protrusion in an axial direction.

In at least one example embodiment, a number of the claw portions is two or more, and the claw portions are equidistantly distributed in a circumferential direction.

In at least one example embodiment, the number of claw portions is three.

In at least one example embodiment, at least two groups of coil lead wires extend in the circumferential direction, each group includes at least two of the coil lead wires, and the coil lead wires in a same group are led out from the same tooth gap and clamped by the same claw portion.

In at least one example embodiment, the claw portion includes a first arm portion and a second arm portion which extend in opposite directions in the circumferential direction respectively, and the first arm portion and the second arm portion clamp different coil lead wires in a same group respectively.

In at least one example embodiment, the protrusion extends from a radially outer side to a radially inner side, and includes a main body portion and a first auxiliary reinforcement portion located on one radial side of the main body portion, and a width of the main body portion in the circumferential direction is greater than that of the first auxiliary reinforcement portion.

In at least one example embodiment, the main body portion is located on the radially outer side relative to the first auxiliary reinforcement portion.

In at least one example embodiment, the molded resin also includes an auxiliary protrusion on one axial side, the auxiliary protrusion extends from the radially outer side to the radially inner side and is located between the adjacent protrusions in the circumferential direction, and the auxiliary protrusion has a circumferential width less than that of the main body portion.

With reference to the following description and accompanying drawings, specific implementations of example embodiments of the present application are disclosed in detail to indicate a manner in which the principles of the present application may be used. It should be understood that the implementations of example embodiments of the present application are not limited thereby in scope. Implementations of example embodiments of the present application encompass many changes, modifications and equivalents within the scope of the spirit and terms of the appended claims.

Features described and/or illustrated with respect to one implementation of an example embodiment may be used in the same or similar manner in one or more other implementations of example embodiments, in combination with, or instead of features in other implementations of example embodiments.

It should be emphasized that the term “include/comprise” when used herein refers to the presence of a feature, integer, step or assembly, but does not exclude the presence or addition of one or more other features, integers, steps or assemblies.

The above and other elements, features, steps, characteristics and advantages of the present disclosure will become more apparent from the following detailed description of the example embodiments with reference to the attached drawings.

### BRIEF DESCRIPTION OF THE DRAWINGS

Elements and features described in one accompanying drawing or one implementation of example embodiments of the present application may be combined with elements and features shown in one or more other accompanying drawings or implementation. Furthermore, in the accompanying drawings, like numerals indicate corresponding components in the several accompanying drawings and may be used to indicate corresponding components used in more than one implementation.

The included accompanying drawings are used to provide a further understanding of the example embodiments of the present application, which constitute a part of the description to illustrate the implementations of the present application, and explain the principle of the present application together with the text description. Apparently, the accompanying drawings in the following description are only some example embodiments of the present application, and those of ordinary skill in the art can also obtain other accompanying drawings according to these drawings without paying creative work. In the accompanying drawings:

FIG. 1 is a schematic view of a split motor 100 according to an example embodiment of the present application.

FIG. 2 is a schematic view of the assembled motor 100 according to the example embodiment of the present application.

FIG. 3 is a sectional view of a portion of the motor 100 according to the example embodiment of the present application, cut along a central axis OO′.

FIG. 4 is a schematic diagram of a coil lead wire 4 in the motor 100 shown in FIG. 1 being clamped by a claw portion 2211.

FIG. 5 is a schematic diagram of the coil lead wire 4 in the motor 100 shown in FIG. 1 being not clamped by the claw portion 2211.

FIG. 6 is a schematic top view of a stator assembly 2 in the motor 100 shown in FIG. 1 along an axial direction OO′.

### DETAILED DESCRIPTION

The foregoing and other features of the present application will become apparent from the following description with reference to the accompanying drawings. In the description and accompanying drawings, specific implementations of example embodiments of the present application are disclosed, which indicate some implementations of example embodiments in which the principles of the present application can be adopted. It should be understood that the present application is not limited to the described implementations of example embodiments. On the contrary, the present application includes all modifications, variations and equivalents that fall within the scope of the appended claims. Various implementations of example embodiments of the present application will be described below with reference to the accompanying drawings. These implementations of example embodiments are only exemplary, but not intended to limit the present application.

In the example embodiments of the present application, the terms “first”, “second”, “upper”, “lower”, etc. are used to distinguish different elements from the names, but do not indicate a spatial arrangement or chronological order of these elements, etc., and these elements should not be limited by these terms. The term “and/or” includes any one and all combinations of one or more of the associated listed terms. The terms “comprising”, “including”, “having” and the like refer to the presence of stated features, elements, component or assemblies, but do not exclude the presence or addition of one or more other features, elements, components or assemblies.

In the example embodiments of the present application, the singular forms “a”, “this” and the like include plural forms, which should be broadly understood as “a kind” or “a class” and not limited to the meaning of “one”. In addition, the term “the” should be understood to include both the singular form and the plural form, unless the context clearly dictates otherwise. Furthermore, the term “according to” should be understood as “at least in part according to . . . ”; and the term “based on” should be understood as “at least in part based on . . . ”, unless the context clearly indicates otherwise.

In addition, in the following description of the example embodiments of the present application, for the convenience of description, a direction extending along a central axis of a motor or a direction parallel to this direction is referred to as an “axial direction”; a radius direction centered on the central axis is referred to as a “radial direction”; a side along the radius direction away from the central axis is referred to as a “radially outer side”; a side along the radius direction close to the central axis is referred to as a “radially inner side”; and a direction around this central axis is referred to as a “circumferential direction”. However, it is worth noting that these are for illustrative convenience only and do not limit the orientation of the motor when used and manufactured.

The example embodiments of the present application will be described below with reference to the accompanying drawings.

An example embodiment of the present application provides a motor.

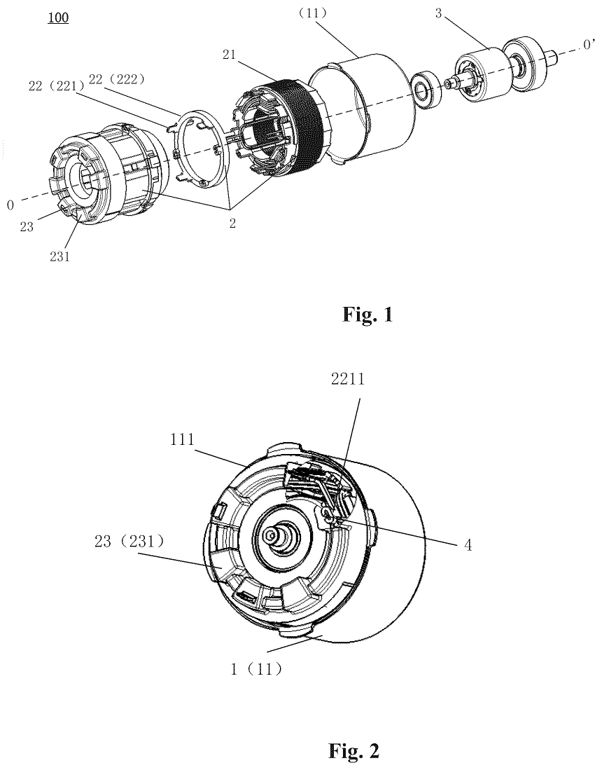

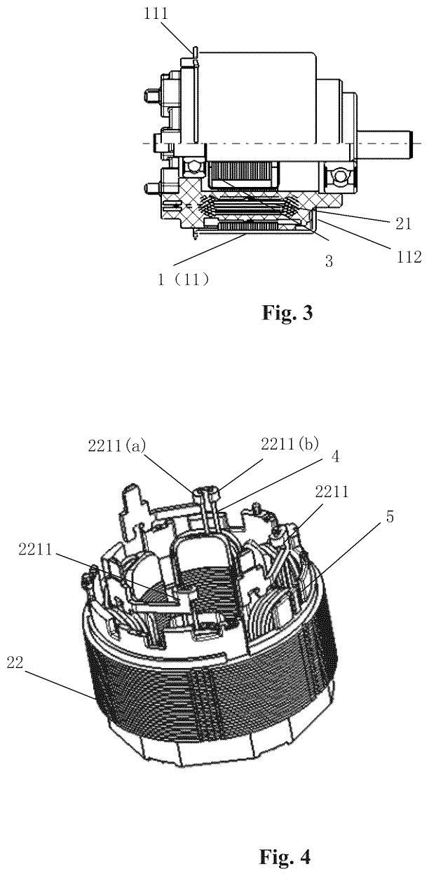

FIG. 1 is a schematic view of a split motor 100 according to an example embodiment of the present application; FIG. 2 is a schematic view of the assembled motor 100 according to the example embodiment of the present application; and FIG. 3 is a sectional view of a portion of the motor 100 according to the example embodiment of the present application, cut along a central axis OO′.

As shown in FIGS. 1, 2 and 3, the motor 100 includes a casing 1 and a stator assembly 2.

The casing 1 has an outer circumferential wall 11 that extends circumferentially around the central axis OO′, an opening portion 111 on one axial side of the outer circumferential wall 11, and a bottom 112 on the other axial side of the outer circumferential wall 11.

The stator assembly 2 is formed by molding. The stator assembly 2 includes a stator 21, a busbar assembly 22, and a molded resin 23. In which, the busbar assembly 22 is supported on the stator 21; and the molded resin 23 covers the busbar assembly 22 in an axial direction.

The busbar assembly 22 includes a metal busbar 221 and a busbar holder 222, and the busbar holder 222 is used to hold the busbar 221.

The molded resin 23 is located on one axial side of the stator 21 and has a protrusion 231 that protrudes toward one axial side. In a cross section perpendicular to the axial direction, a projection of the busbar 221 at least partially overlaps with a projection of the protrusion 231; and the molded resin 23 is filled between the busbar 221 and the protrusion 231.

According to the motor 100 in this example embodiment of the present application, the protrusion 231 is provided on the surface of the molded resin 23, and the metal busbar 221 is embedded in the protrusion 231. Since the projection of the busbar 221 at least partially overlaps with the projection of the protrusion 231, the protrusion 231 can be axially supported by the busbar 221, which increases the strength of the protrusion 231. The molded resin 23 will not be prone to cracking when an assembling tool abuts against the surface of the protrusion 231 of the molded resin 23 and applies a pressure, which facilitates the assembly of the molded stator assembly 2 into the casing 1.

As shown in FIG. 2, the busbar 221 has a claw portion 2211, and the claw portion 2211 may clamp a coil lead wire 4 of the stator 21. The claw portion 2211 may extend in an axial direction and/or the claw portion 2211 may extend in a direction perpendicular to the axial direction. For example, the claw portion 2211 may extend in a circumferential direction. In a cross section perpendicular to the axial direction, the projection of the protrusion 231 at least partially overlaps with a projection of the claw portion 2211. Therefore, when the claw portion 2211 extends along the axial direction, the axial rigidity can be increased, thereby improving the support strength to the protrusion 231. In addition, when the claw portion 2211 extends along a direction perpendicular to the axial direction, a stressed area of the claw portion 2211 in the direction perpendicular to the axial direction can be increased, and the support strength to the protrusion 231 can also be improved. In addition, the wrapping of the molded resin 23 makes the connection between the claw portion 2211 and the coil lead wire more reliable.

In the present application, the claw portion 2211 may extend into the protrusion 231 in an axial direction. Therefore, the claw portion 2211 has a better supporting effect on the protrusion 231 and further improves the mechanical strength of the protrusion 231.

In the present application, the number of claw portions 2211 is two or more. For example, the number of claw portions 2211 is three. Two or more claw portions 2211 are distributed equidistantly in a circumferential direction. Therefore, the claw portions 2211 are equidistantly distributed in the circumferential direction. The protrusions 231 are also equidistantly distributed in the axial direction. Therefore, when the molded stator assembly 2 is pressed into the casing 1 using an assembling tool, the molded stator assembly 2 is evenly stressed, so the pressing accuracy can be improved. In addition, when three protrusions 231 are formed, a supporting surface is formed by the surfaces of the three protrusions 231 to ensure the stability during the process of pressing the molded stator assembly 2 into the casing 1.

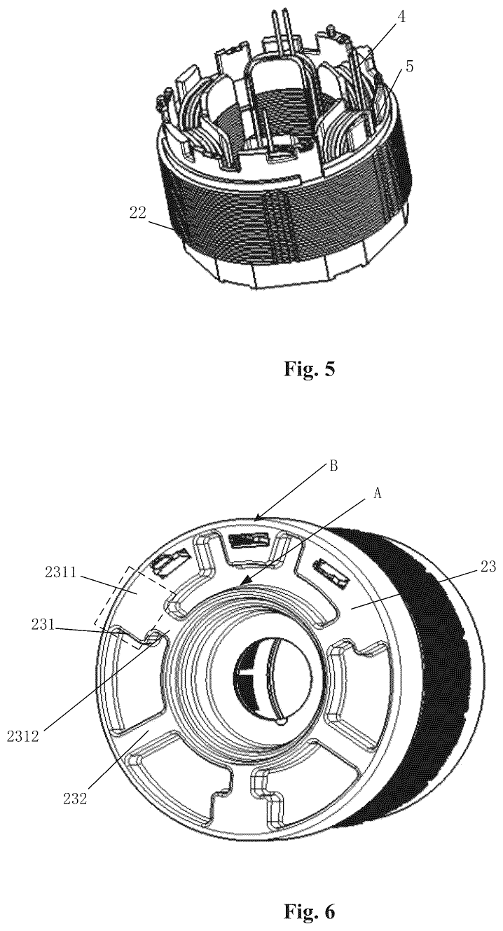

FIG. 4 is a schematic diagram of a coil lead wire 4 in the motor 100 shown in FIG. 1 being clamped by the claw portion 2211; and FIG. 5 is a schematic diagram of the coil lead wire 4 in the motor 100 shown in FIG. 1 being not clamped by the claw portion 2211.

As shown in FIGS. 4 and 5, the coil lead wires 4 are arranged in a plurality of groups in the circumferential direction, for example, at least two groups. Each group includes a plurality of coil lead wires 4. For example, each group includes at least two coil lead wires 4. The coil lead wires 4 of the same group are led out from the same tooth gap 5 and are clamped by the same claw portion 2211. Thus, a winding pattern matching the protrusions 231 may be formed, and the claw portions 2211 facilitate clamping the coil lead wires 4 while supporting the protrusions 231.

Moreover, the claw portion 2211 has a first arm portion 2211 (a) and a second arm portion 2211 (b) which extend in opposite directions in the circumferential direction respectively, and the first arm portion 2211 (a) and the second arm portion 2211 (b) clamp different coil lead wires 4 in the same group respectively. Therefore, the claw portion 2211 has a certain extension in the circumferential direction, with an extension direction facing the opposite side, thereby reliably supporting the protrusion 231 with an increased circumferential width and facilitating supporting the coil lead wire.

FIG. 6 is a schematic top view of a stator assembly 2 in the motor 100 shown in FIG. 1 along an axial direction OO′.

As shown in FIG. 6, the molded resin 23 is in an annular shape, and has a radially inner side and a radially outer side that correspond to an inner ring A and an outer ring B of the annular shape, respectively. The protrusion 231 extends from the radially outer side to the radially inner side (for example, the protrusion 231 extends in a radial direction). The protrusion 231 may include a main body portion 2311 and a first auxiliary reinforcement portion 2312 located on one radial side of the main body portion 2311 in the radial direction. In the circumferential direction, the main body part 2311 has a width greater than that of the first auxiliary reinforcement portion 2312. Thus, the strength of the protrusion 231 can be ensured, and the amount of the molded resin 23 can also be saved.

As shown in FIG. 6, the main body portion 2311 is located on the radially outer side relative to the first auxiliary reinforcement portion 2312. That is, the projection of the main body portion 2311 at least partially overlaps with the projection of the claw portion 2211. Therefore, a radial position of the main body portion 2311 can be set in accordance with a radial position of the claw portion 2211. In addition, the claw portion 2211 is located at a position close to the outer side in the radial direction, so that enough operating space can be provided in the operation of clamping the coil lead wire 4 with the claw portion 2211.

In the present application, as shown in FIG. 6, the molded resin 23 also has an auxiliary protrusion 232 on one axial side. The auxiliary protrusion 232 extends from the radially outer side to the radially inner side (for example, the auxiliary protrusion 232 extends along the radial direction), and is located between adjacent protrusions 231 in the circumferential direction. In addition, the auxiliary protrusion 232 has a circumferential width less than that of the main body portion 2311. For example, the circumferential width of the auxiliary protrusion 232 may be less than or equal to that of the first auxiliary reinforcement portion 2312. Therefore, the pressure-bearing strength of the molded resin can be enhanced and a resin material can be saved.

In the present application, as shown in FIG. 1, the motor 100 may further include a rotor 3. The rotor 3 is configured to be opposite to the stator assembly 2 in a radial direction. For example, as shown in FIG. 1, the rotor 3 is located on the radially inner side of the stator assembly 2. Detailed description of the rotor 3 may refer to related technologies.

It is worth noting that the above content is only an exemplary description of the composition and structure of the motor related to the present application, but the present application is not limited thereto, and appropriate variations can also be made on the basis of the above example embodiments. In addition, the above content only exemplarily describes respective components, but the present application is not limited thereto, and the specific content of the respective components can also refer to related technologies. The motor may also include other components, such as a bearing, etc. For details, reference may be made to related technologies, which will be omitted here.

The present application is described above in conjunction with specific implementations of example embodiments, but those skilled in the art should be clear that these descriptions are exemplary and are not intended to limit the protection scope of the present application. Those skilled in the art can make various variations and modifications to the present application according to the spirit and principles of the present application, and these variations and modifications are also within the scope of the present application.

The preferred implementations of example embodiments of the present application are described above with reference to the accompanying drawings. Many features and advantages of these implementations of example embodiments are clear according to the detailed description. Therefore, the accompanying claims are intended to cover all these features and advantages that fall within the true spirit and scope of these implementations of example embodiments. Furthermore, since those skilled in the art is prone to think of many modifications and changes, it is not intended to limit the implementations of example embodiments of the present application to the precise structure and operations shown and described, but to cover all suitable modifications and equivalents that fall within its scope.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a casing including an outer circumferential wall that extends circumferentially around a central axis, an opening portion on one axial side of the outer circumferential wall, and a bottom on another axial side of the outer circumferential wall; and
a stator assembly which is molded; wherein
the stator assembly includes:
a stator;
a busbar assembly; and
a molded resin;
the busbar assembly is supported on the stator;
the molded resin covers the busbar assembly in an axial direction;
the busbar assembly includes a metal busbar;
the molded resin is located on one axial side of the stator and includes protrusions that protrude toward one axial side;
in a cross section perpendicular to the axial direction, a projection of the busbar at least partially overlaps with a projection of the protrusion; and
the molded resin is filled between the busbar and the protrusion.

2. The motor according to claim 1, wherein
the busbar includes claw portions that clamp a coil lead wire of the stator; and
in a cross section perpendicular to the axial direction, the projection of the protrusion at least partially overlaps with a projection of the claw portion.

3. The motor according to claim 2, wherein the claw portion extends into the protrusion in the axial direction.

4. The motor according to claim 2, wherein
a number of the claw portions is two or more; and
the claw portions are equidistantly distributed in a circumferential direction.

5. The motor according to claim 4, wherein the number of the claw portions is three.

6. The motor according to claim 2, wherein
at least two groups of coil lead wires are arranged in the circumferential direction;
each group includes at least two of the coil lead wires; and
the coil lead wires in a same group are led out from a same tooth gap and clamped by a same claw portion.

7. The motor according to claim 6, wherein
the claw portion includes a first arm portion and a second arm portion which extend in opposite directions in the circumferential direction respectively; and
the first arm portion and the second arm portion clamp different coil lead wires in a same group respectively.

8. The motor according to claim 2, wherein
the protrusion:
extends from a radially outer side to a radially inner side; and
includes a main body portion and a first auxiliary reinforcement portion located on one radial side of the main body portion; and
a width of the main body portion in the circumferential direction is greater than that of the first auxiliary reinforcement portion.

9. The motor according to claim 8, wherein the main body portion is located on the radially outer side relative to the first auxiliary reinforcement portion.

10. The motor according to claim 8, wherein
the molded resin includes an auxiliary protrusion on one axial side;
the auxiliary protrusion extends from the radially outer side to the radially inner side and is located between the adjacent protrusions in the circumferential direction; and
the auxiliary protrusion has a circumferential width less than that of the main body portion.
